(19) United States
(12) Patent Application Publication
(10) Pub. No.: US 2007/0274900 A1
(43) Pub. Date: Nov. 29, 2007

(54) PROCESSES FOR OBTAINING CHLORINE FROM MIXTURES OF CHLORINE, WATER, HYDROGEN CHLORIDE AND OXYGEN, AND INCORPORATION OF SUCH PROCESSES INTO ISOCYANATE PRODUCTION PROCESSES

(75) Inventors: Andreas Bulan, Langenfeld (DE); Rainer Weber, Odenthal (DE); Jesko Zank, Koln (DE); Axel Eble, Koln (DE); Knud Werner, Krefeld (DE)

Correspondence Address: CONNOLLY BOVE LODGE & HUTZ, LLP, P O BOX 2207, WILMINGTON, DE, 19899, US

(73) Assignee: Bayer Material Science AG, Leverkusen (DE)

(21) Appl. No.: 11/752,558

(22) Filed: May 23, 2007

(30) Foreign Application Priority Data
May 23, 2006 (DE) 102006024518.0

(51) Int. Cl. C01B 7/04

(52) U.S. Cl. 423/502

(57) ABSTRACT

Processes comprising: (a) providing an initial gas mixture comprising chlorine, water, hydrogen chloride and oxygen; (b) cooling the initial gas mixture to form condensed hydrochloric acid and an intermediate chlorine-containing gas mixture; (c) contacting the intermediate gas mixture with a water-containing phase under a set of conditions selected from a pressure, a temperature and combinations thereof to form a chlorine hydrate-containing phase and a remaining gas mixture; (d) separating the chlorine hydrate-containing phase from the remaining gas mixture; (e) subjecting the chlorine hydrate-containing phase to a set of conditions selected from heat, pressure relief and combinations thereof to release chlorine and form a residual chlorine hydrate/water-containing phase; and (f) separating the released chlorine from the residual chlorine hydrate/water-containing phase.

### BACKGROUND OF THE INVENTION

In the preparation of a large number of chemical compounds using chlorine or phosgene, for example, in the preparation of isocyanates or in the chlorination of aromatic compounds, hydrogen chloride is formed as a by-product. The hydrogen chloride can be converted back into chlorine by electrolysis or by oxidation with oxygen, and the chlorine can then be re-used in the initial chemical reactions. The oxidation of hydrogen chloride (HCl) to chlorine (Cl₂) takes place by reaction of hydrogen chloride and oxygen (O₂) according to the equation:

4HCl+O₂ [symbol] 2Cl₂+2H₂O

The reaction can be carried out in the presence of catalysts at temperatures of approximately from 250 to 450° C. Suitable catalysts for this type of thermal reaction, which is generally known as a Deacon reaction, are known.

As an alternative, processes are known in which the reaction of hydrogen chloride with oxygen is activated non-thermally. Such processes are described, for example, in W. Stiller, Nichtthermische aktivierte Chemie, Birkhäuser Verlag, Basle, Boston, 1987, p. 33-34, p. 45-49, p. 122-124, p. 138-145. Additional non-thermally activated processes are disclosed, for example, in RU-A 2253607, JP-A-59073405, DD-A-88309, SU 1801943 A1. Non-thermally activated reactions are understood as including, for example, stimulation of the reaction by any of the following: non-thermal energy carriers, such as, photons, electrons, ions and recoil nuclei, the possible energy range being in the range from 0.01 eV to 10⁸ eV. JP 59073405 describes photooxidation of gaseous hydrogen chloride at pressures of from 0.5 to 10 atm and temperatures of from 0 to 400° C., using, inter alia, pulsed coherent laser radiation (3×10⁻¹⁵ s pulse duration and 0.01-100 J energy, e.g., KrF laser (wavelength 249 nm, 10 W power)) or a high-voltage mercury lamp (100 W power) or a combination of the two mentioned radiation sources, to stimulate the reactants. Non-thermal stimulation can be carried out by UV radiation with both radiation sources.

RU-A 2253607 describes a chlorine preparation process which is carried out at ftom 25 to 30° C. and in which a gaseous hydrogen chloride/air mixture flows through a tubular reactor at a velocity of from 1 to 30 m/s and activation of the reactants takes place in a reaction zone by means of a mercury vapour lamp with a volumetric radiation density in the range of from 10×10⁻⁴ to 40×10⁻⁴ W/cm³ and a pressure of 0.1 MPa. It is known to the person skilled in the art that mercury vapour lamps emit radiation in different wavelength ranges according to the filling pressure. Low-pressure mercury vapour lamps work at a pressure below 150 Pa and emit radiation of wavelength 185 nm and 254 nm, that is to say in the UV range.

A common feature of such known processes is that the reaction of hydrogen chloride with oxygen yields a gas mixture that contains water, unreacted hydrogen chloride and unreacted oxygen, in addition to the target product chlorine, as well as optionally further minor constituents such as carbon dioxide. In order to obtain pure chlorine from such reaction mixtures, the product gas mixture is cooled after the reaction to such an extent that water of reaction and hydrogen chloride condense out in the form of concentrated hydrochloric acid. The resulting hydrochloric acid can be separated off and the gaseous reaction mixture that remains is freed of residual water by washing with sulfuric acid or by other methods such as drying with zeolites. The reaction gas mixture, which is then free of water, is subsequently compressed, whereby oxygen and other gas constituents remain in the gas phase and can be separated from the liquefied chlorine. Such processes for obtaining pure chlorine from gas mixtures are described, for example, in Offenlegungsschriften DE 19535716 A1 and DE 10235476 A1. The purified chlorine is then conveyed to its use, for example in the preparation of isocyanates.

A fundamental disadvantage of the above-mentioned chlorine preparation processes is the comparatively high outlay in terms of energy that is required to liquefy the chlorine gas stream.

A further particular disadvantage of the known processes is the loss of chlorine that results from the chlorine liquefaction, which arises when partial streams of the oxygen stream, which is conventionally fed back to the HCl oxidation reaction and which contains residual chlorine, are discarded or destroyed. Because the pure oxygen that is conventionally used is complex to prepare and therefore expensive, there is a need for an improvement to the processes.

### BRIEF SUMMARY OF THE INVENTION

The invention relates, in general, to a process for the preparation of chlorine by thermal reaction of hydrogen chloride with oxygen using catalysts and/or by non-thermal activated reaction of hydrogen chloride with oxygen, in which the gas mixture formed in the reaction, which consists at least of the target products chlorine and water, unreacted hydrogen chloride and oxygen, as well as further minor constituents such as carbon dioxide and nitrogen, and optionally phosgene, is cooled in order to condense hydrochloric acid, and the resulting liquid hydrochloric acid is separated from the gas mixture. More particularly, the invention relates to the separation of the chlorine gas from the gas mixture after condensation of the liquid hydrochloric acid.

It has been found that the above-described disadvantages can be overcome if, after separation of the unreacted hydrogen chloride, the chlorine-containing gas mixture is brought into contact with water or an aqueous solution and is adjusted to a temperature and to a pressure such that a chlorine hydrate-containing phase forms, in particular chlorine hydrate precipitated in a solid form, and subsequently releasing chlorine from the chlorine hydrate-containing phase.

One embodiment of the present invention includes processes which comprise: (a) providing an initial gas mixture comprising chlorine, water, hydrogen chloride and oxygen; (b) cooling the initial gas mixture to form condensed hydrochloric acid and an intermediate chlorine-containing gas mixture (also referred to herein as simply “the chlorine-containing gas mixture” or “the intermediate gas mixture”); (c) contacting the intermediate gas mixture with a water-containing phase under a set of conditions selected from a pressure, a temperature and combinations thereof, to form a chlorine hydrate-containing phase and a remaining gas mixture; (d) separating the chlorine hydrate-containing phase from the remaining gas mixture; (e) subjecting the chlorine hydrate-containing phase to a set of conditions selected from heat, pressure relief and combinations thereof to release chlorine and form a residual chlorine hydrate/water-containing phase; and (f) separating the released chlorine from the residual chlorine hydrate/water-containing phase.

Another embodiment of the invention includes processes for the preparation of chlorine by thermal reaction of hydrogen chloride with oxygen using catalysts and/or by non-thermal activated reaction of hydrogen chloride with oxygen, in which (a) the gas mixture formed in the reaction, which includes at least the target products chlorine and water, optionally unreacted hydrogen chloride and oxygen, as well as optionally further constituents such as carbon dioxide and nitrogen, and optionally phosgene, is cooled to condense hydrochloric acid, (b) at least part of the resulting liquid hydrochloric acid is optionally separated from the chlorine-containing gas mixture, wherein the resulting chlorine-containing gas mixture is brought into contact with a water-containing phase and adjusted to a temperature and/or to a pressure such that a chlorine hydrate-containing phase forms, wherein oxygen and optional further constituents remain in the gas phase and are separated from the chlorine hydrate-containing phase, the resulting chlorine-hydrate-containing phase being separated from the remaining gases and heated and/or relieved of pressure, so that chlorine is freed from the chlorine hydrate in the form of a gas or is obtained in the form of a separate liquid phase, and the chlorine is separated from the water-containing phase and then used further.

The water-containing phase can comprise water or an aqueous solution or a (dilute) aqueous dispersion of chlorine hydrate. In various preferred embodiments wherein the residual chlorine hydrate/water-containing phase is fed back into the contacting of the intermediate gas mixture with the water-containing phase, the water-containing phase can comprise an aqueous solution or a (dilute) aqueous dispersion of chlorine hydrate.

In various embodiments of processes according to the invention, the addition of the water-containing phase can be adjusted such that chlorine hydrate is obtained as a solid in the gas phase or is deposited on cooled surfaces, or the water-containing phase can be added in excess so that, in addition to the gas phase, a suspension of chlorine hydrate in water is formed.

Other gas phase constituents which are present in addition to chlorine in the intermediate gas mixture can be separated from the resulting chlorine hydrate-containing phase, before or after separation of the condensed hydrochloric acid, by gas/solid separation or gas/liquid separation in a manner known in principle to the person skilled in the art.

In various embodiments of the processes according to the invention, the chlorine hydrate-containing phase can then be subjected to a set of conditions by adjusting temperature and pressure such that, under such conditions, the chlorine hydrate dissolves in the water with the liberation of chlorine gas, or sublimes to water vapour and chlorine gas, or is obtained in the form of a two-phase system of liquid chlorine and water, which in turn can be separated. The chlorine gas can thus be obtained in a simple manner in purified form as a gas stream.

Additional embodiments of the processes according to the invention include processes wherein the initial gas mixture is a reaction product of an oxidation of hydrogen chloride and oxygen and the hydrogen chloride is a product of an isocyanate production process. In various preferred embodiments of the processes according to the invention, the processes further include feeding at least a portion of the released chlorine back to the isocyanate production process.

### BRIEF SUMMARY OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings, embodiment(s) which is(are) presently preferred. It should be understood, however, that the invention is not limited to the precise arrangements and instrumentalities shown.

In the Figs.:

FIG. 1 is a representative flow chart diagram of a process in accordance with an embodiment of the present invention; and

FIG. 2 is a representative flow chart diagram of a process in accordance with another embodiment of the present invention.

### DETAILED DESCRIPTION OF THE INVENTION

As used herein, the singular terms “a” and “the” are synonymous and used interchangeably with “one or more” or “at least one.” Accordingly, for example, reference to “a gas” herein or in the appended claims can refer to a single gas or more than one gas. Additionally, all numerical values, unless otherwise specifically noted, are understood to be modified by the word “about.”

In various preferred embodiments, the water-containing phase is contacted with the intermediate gas mixture in excess, such that a suspension of chlorine hydrate in water is formed. In various more preferred embodiments, chlorine hydrate can be separated in the form of a solid from the chlorine hydrate suspension, and then the chlorine can be obtained from the chlorine hydrate solid.

In certain particularly preferred embodiments, where a suspension of chlorine hydrate in water is formed, the chlorine hydrate suspension can be fed to a solid/liquid separation in a known manner, and the chlorine hydrate can thereby be separated from the aqueous phase. In this manner, a smaller portion of the chlorine hydrate-containing phase can be subjected to pressure and temperature conditions necessary to release the chlorine (energy-related advantage) and a higher purity of the chlorine can be achieved.

In further various preferred embodiments, the water-containing phase can be added for contact with the intermediate gas mixture in metered amounts in such a manner that chlorine hydrate forms in the gas stream as a dry solid.

In certain preferred embodiments, the chlorine hydrate-containing phase comprises chlorine hydrate in the form of a crystalline solid, which can then be separated from the residual gas.

In various preferred embodiments, the formation of the chlorine hydrate-containing phase can be achieved by lowering the temperature at constant or increasing pressure. In various preferred embodiments, the formation of the chlorine hydrate-containing phase can be achieved by raising the pressure at constant temperature.

In various preferred embodiments, the release of the chlorine from the chlorine hydrate-containing phase can be achieved by raising the temperature at constant or decreasing pressure. In various preferred embodiments, the release of the chlorine from the chlorine hydrate-containing phase can be achieved by lowering the pressure at constant temperature.

Various preferred embodiments of processes according to the invention can further include separating residual water from the released chlorine after separation of the released chlorine from the residual chlorine hydrate/water-containing phase. To that end, the released chlorine, for example, can be further purified in a variety of known manners, such as, by adsorption, condensation, combinations thereof; or, particularly preferably, by absorption of water vapour that may be present therein, in particular using concentrated sulfuric acid.

Various preferred embodiments of processes according to the invention can further include feeding at least part of the residual chlorine hydrate/water-containing phase back to the contacting of the intermediate gas mixture with the water-containing phase.

In various preferred embodiments of processes according to the invention, at least the formation of the chlorine hydrate-containing phase is carried out at elevated pressure, in particular at a pressure of from 3 to 30 bar (from 3000 to 30,000 hPa).

Preference is also given to embodiments of the invention wherein the formation of the chlorine hydrate-containing phase is carried out at a temperature below 30° C. Particularly preferably, the formation of the chlorine hydrate-containing phase is carried out at a temperature of not more than 28° C. The pressure is more preferably at least 8.4 bar (8400 hPa).

In various preferred embodiments of the present invention wherein the process is carried out in continuous fashion, the mass flow of the water-containing phase supplied for contacting with the intermediate gas mixture to form the chlorine hydrate-containing phase can preferably be pre-cooled in such a manner that the desired temperature for the chlorine hydrate formation is established at least in part by the addition of the pre-cooled water-containing phase.

It is possible in various preferred embodiments to provide the water-containing phase with one or more additives which lower the solidus of water ice. To that end, in particular, additives that lower the melting point of ice are chosen. Suitable additives include, but are not limited to, water-soluble organic compounds which under the chosen conditions do not enter into a spontaneously irreversible reaction with the chlorine. Preference is given, however, to water-soluble inorganic compounds, particularly preferably to salts that dissociate completely or to hydrogen chloride.

A hydrogen chloride-containing aqueous solution can be used as the water-containing phase. Separation, either partial or complete, of the intermediate gas mixture and the condensed hydrochloric acid is optional, but preferred in a variety of embodiments. In embodiments wherein the water-containing phase comprises a hydrogen chloride-containing aqueous solution the optional (partial or complete) separation of the condensed, liquid hydrochloric acid may preferably be omitted.

In particularly preferred embodiments of the invention, the additive for lowering the solidus, or the melting point, of water is a chloride and/or hypochlorite and/or hydrogen chloride, in particular an alkali or alkaline earth chloride and/or hypochlorite, particularly preferably sodium chloride, potassium chloride or calcium chloride.

In certain embodiments, the intermediate gas mixture can be brought into contact with the water-containing phase, which may already contain chlorine hydrate, by introduction in bubble form. Such introduction can be effected, for example, discontinuously by passing the gas mixture into a corresponding receptacle containing water or the aqueous solution or aqueous chlorine hydrate suspension. It can also be carried out, for example, semi-continuously by passing the gas mixture into a corresponding receptacle to which additional water/aqueous solution or aqueous chlorine hydrate suspension is metered constantly. The incoming intermediate gas mixture is particularly preferably brought into contact continuously by being passed in bubble form into the water or into the aqueous solution or into the aqueous chlorine hydrate suspension, an aqueous chlorine-hydrate-containing suspension being drawn off continuously and water or saturated mother liquor being metered in continuously. Suitable apparatuses are bubble columns as well as stirred crystallisers and forced circulation crystallisers with and without further built-in elements for separating off both solids-rich and low-solids fractions. Such apparatuses are described, for example, in Mersmann “Crystallization Technology Handbook”, Marcel Decker, New York, 2001, p. 323-392, the entire contents of which are incorporated herein by reference.

In certain preferred embodiments, the introduction of the intermediate chlorine-containing gas mixture in bubble form can be carried out in bubble columns, preferably in continuous bubble columns, particularly preferably counter-currently to the continuous aqueous phase. The ratio of the aqueous phase that is metered into the incoming chlorine-containing gas, the temperature and the pressure can be adjusted such that the solids content of the suspension is from 1 to 50 parts by volume, preferably from 3 to 30 parts by volume, particularly preferably from 10 to 20 parts by volume.

In various preferred embodiments of the process, the introduction of the chlorine-containing gas mixture in bubble form can be carried out in stirred crystallisers, preferably in forced circulation crystallisers, particularly preferably in crystallisers without stirring members using the gas stream that is introduced for internal or external circulation, particularly preferably in crystallisers having additional built-in elements for separating off solids-rich fraction. The ratio of the aqueous phase that is metered into the incoming chlorine-containing gas, the temperature and the pressure can be adjusted such that the solids content on average, based on the volume of the crystalliser, is from 1 to 50 parts by volume, preferably from 5 to 40 parts by volume, particularly preferably from 10 to 30 parts by volume. The product stream (i.e., the chlorine hydrate-containing phase) is particularly preferably conveyed away in a sedimentation zone which is separated off by built-in elements, with a solids content of from 30 to 60 parts by volume, preferably from 40 to 50 parts by volume.

In various preferred embodiments of the invention, the intermediate gas mixture can be brought into contact with the water-containing phase, which may already contain chlorine hydrate, by feeding the intermediate gas mixture to the gas space located above the water-containing phase. Such embodiments can be carried out over a wide range of addition parameters because the chlorine is absorbed comparatively quickly and efficiently by the aqueous phase.

In various preferred embodiments, the chlorine gas-containing gas mixture can be guided continuously counter-currently to a stream of the aqueous phase that is present in discrete form, such as, for example, droplets. The aqueous phase can be water, an aqueous solution or a chlorine-hydrate-containing suspension. This can be particularly advantageous when the proportion of inert gases present in the intermediate gas mixture is greater than the proportion of chlorine in the intermediate gas mixture, for example when the chlorine-containing gas mixture comes from a hydrogen chloride oxidation carried out using air.

The amount of water guided counter-currently in discrete form can preferably be adjusted such that the water is absorbed completely into the resulting chlorine hydrate and can be separated from the gas stream. For dissipation of the heat of crystallisation, the water is cooled and/or the chlorine-containing gas stream is cooled.

In certain preferred embodiments, a portion of the resulting chlorine hydrate suspension can be circulated and fed back to the gas mixture counter-currently.

It can likewise be particularly advantageous to make further use of heat generated during various stages of processes in accordance with the embodiments of the invention. For example, the heat of hydration of a hydrogen chloride-water solution can be used to provide heat for the decomposition of chlorine hydrate. It is likewise preferably possible to use heated cooling water from the crystallisation in the chlorine hydrate decomposition. The inventive processes can be carried out particularly economically as a result.

Chlorine hydrate within the scope of the invention is understood as meaning all forms of chlorine hydrates, in particular those which can be formed below 30° C. at different pressures from chlorine and water, preferably chlorine hydrates having the following molar ratio of chlorine to water: 1:1, 1:4, 1:5.75, 1:5.91 to 1:6.12, 1:6, 1:6.12, 1:7, 1:8, 1:10, 1:12, 1:99, particularly preferably chlorine hexahydrate and chlorine heptahydrate.

Chlorine hydrates are known in principle from the prior art and are described, for example, in the publication: A. T. Bozzo; Hsia-Sheng Chen, J. R. Kass, A. J. Barduhn DESALINATION, 16(1975), p. 303-320 “The Properties of the Hydrates of Chlorine and Carbon Dioxide” in: GMELIN, Handbuch der anorganischen Chemie, Volume 1, Section 2, “Fluor, Chlor Brom Jod”, Heidelberg 1909, p. 66-73 and in: J. A. A. Ketelaar; Electrochemical Technology (1967), Vol. 5, No. 3-5, p. 143-147 “The Drying and Liquefaction of Chlorine and the Phase Diagram Cl₂—H₂O”, the entire contents of each of which are incorporated herein by reference.

The chlorine hydrate in solid form can be amorphous, semi-crystalline or crystalline. According to the crystallinity and the different crystalline states, the solid can contain water bound in various amounts. The water can be incorporated in regular form into the crystal lattice or can be associated amorphously. The crystallinity and the crystalline state can be determined in a simple manner known to the person skilled in the art, for example by X-ray diffractometry.

When a process according to the invention includes separation of oxygen and optionally minor constituents from the intermediate chlorine-containing gas mixture, a very pure chlorine gas can be obtained, the energy requirement for the chlorine gas purification carried out by the process being markedly reduced as compared with the processes known hitherto. The gas mixture obtained as a further gas stream contains substantially oxygen and, as minor constituents, carbon dioxide and optionally nitrogen, and is substantially free of chlorine.

A fundamental disadvantage of the known current HCl oxidation processes is that pure oxygen having an O₂ content of in most cases at least 98 vol. % must be used in the oxidation of hydrogen chloride. In various embodiments of the processes according to the invention it is possible to dispense with the use of pure oxygen.

Processes according to the invention can employ air or air enriched with oxygen as the oxygen source for the reaction of hydrogen chloride with oxygen, and the remaining gas mixture (after separation of the chlorine hydrate-containing phase) containing oxygen and optionally constituents such as carbon dioxide and nitrogen is optionally discarded. For example, the oxygen-containing gas mixture, optionally after preliminary purification, can be released directly into the surrounding air in a controlled manner.

A process carried out using air or air enriched with oxygen has further advantages. On the one hand, the use of air instead of pure oxygen eliminates a considerable cost factor, because the working-up of air is substantially less complex in technical terms. Because an increase in the oxygen content displaces the reaction equilibrium in the direction of chlorine preparation, the amount of inexpensive air or oxygen-enriched air can be increased, if necessary, without hesitation. Furthermore, a major problem of the known Deacon processes and Deacon catalysts is the occurrence of hot-spots at the surface of the catalyst, which is very difficult to control. Overheating of the catalyst readily leads to irreversible damage, which impairs the oxidation process. Various attempts have been made to avoid such local overheating (e.g., by diluting the bulk catalyst), but have not provided satisfactory solutions. An air mixture containing, for example, up to 80% inert gases permits dilution of the feed gases (reactants) and accordingly also a controlled reaction procedure by avoiding local overheating of the catalyst. The development of heat is inhibited by the use of this preferred measure, and consequently the useful life of the catalyst is increased (by reducing the volume-based activity of the catalyst). Furthermore, the use of inert gas components will result in better heat dissipation (absorption of heat by the inert gases), which additionally contributes to preventing hot-spots.

Although it is known in principle from the prior art according to FR 1497776, U.S. Pat. No. 2,602,021, NL 112095, NL 276976, NL 6404460, DE 888386, U.S. Pat. No. 2,577,808, GB 689370, EP 184413, DE 1252180 that HCl oxidation using air or air enriched with oxygen is possible, such processes are generally unsuccessful technically because of the complex and expensive working-up of the Deacon reaction products resulting from these known methods with the conventionally known work-up steps. In addition, these known processes are unsuccessful because of the inadequate separation of the residual gas from the chlorine, which is an expensive valuable substance, the majority of which is lost because of a high discharge of waste gases, which the use of air or of air enriched with oxygen requires. With an inert gas content of, for example, up to 80 vol. %, it is not expedient in the known processes to recirculate the inert gases containing residual chlorine in order to recover residual chlorine, whose content in the residual gas can reach up to 10% (DE-10235476-A1). Accordingly, at least part of the purified process gas must be discarded, which means the loss of a large amount of chlorine and high destruction costs of the residual gases, and which consequently impairs the economy of the known process considerably.

As a result of the efficient work-up of process gas that is provided by various embodiments of the invention, it is possible for the first time to carry out, for example, the Deacon process economically using commercial oxygen of low purity or using air or air enriched with oxygen. By means of crystallization, for example, chlorine from the process gas stream can successfully be separated from oxygen, optionally nitrogen and further minor components. The chlorine obtained by the processes according to the invention can then be reacted according to processes known in the prior art, for example with carbon monoxide to give phosgene, which can be used for the preparation of MDI or TDI from MDA or TDA, respectively.

As already described above, the catalytic process for hydrogen chloride oxidation known as the Deacon process can preferably be used to provide the initial gas mixture for various embodiments of the present invention. In Deacon processes, hydrogen chloride is oxidized with oxygen in an exothermic equilibrium reaction to give chlorine, with the formation of water vapour. The reaction temperature is conventionally from 150 to 500° C., and the conventional reaction pressure is from 1 to 25 bar. Because this is an equilibrium reaction, it is expedient to work at the lowest possible temperatures at which the catalyst still exhibits sufficient activity. Furthermore, it is expedient to use oxygen in more than stoichiometric amounts. A two- to four-fold oxygen excess, for example, is conventional. Because there is no risk of selectivity losses, it can be economically advantageous to work at a relatively high pressure and accordingly with a longer dwell time compared with normal pressure.

Suitable preferred catalysts for the Deacon process contain ruthenium oxide, ruthenium chloride or other ruthenium compounds on silicon dioxide, aluminium oxide, titanium dioxide or zirconium dioxide as support. Suitable catalysts can be obtained, for example, by applying ruthenium chloride to the support and then drying or drying and calcining. In addition to or instead of a ruthenium compound, suitable catalysts can also contain compounds of different noble metals, for example gold, palladium, platinum, osmium, iridium, silver, copper or rhenium. Suitable catalysts can also contain chromium(III) oxide.

The catalytic oxidation of hydrogen chloride can be carried out adiabatically or, preferably, isothermally or approximately isothermally, discontinuously, but preferably continuously, as a fluidised or fixed bed process, preferably as a fixed bed process, particularly preferably in tubular reactors on heterogeneous catalysts at a reactor temperature of from 180 to 500° C., preferably from 200 to 400° C., particularly preferably from 220 to 350° C., and a pressure of from 1 to 25 bar (from 1000 to 25,000 hPa), preferably from 1.2 to 20 bar, particularly preferably from 1.5 to 17 bar and especially from 2.0 to 15 bar.

Conventional reaction apparatuses in which the catalytic oxidation of hydrogen chloride is carried out are fixed bed or fluidised bed reactors. The catalytic oxidation of hydrogen chloride can preferably also be carried out in a plurality of stages.

In the case of the isothermal or approximately isothermal procedure, it is also possible to use a plurality of reactors, that is to say from 2 to 10, preferably from 2 to 6, particularly preferably from 2 to 5, especially from 2 to 3 reactors, connected in series with additional intermediate cooling. The oxygen can be added either in its entirety, together with the hydrogen chloride, upstream of the first reactor, or distributed over the various reactors. This series connection of individual reactors can also be combined in one apparatus.

A further preferred embodiment of a device suitable for the process consists in using a structured bulk catalyst in which the catalytic activity increases in the direction of flow. Such structuring of the bulk catalyst can be effected by variable impregnation of the catalyst support with active substance or by variable dilution of the catalyst with an inert material. There can be used as the inert material, for example, rings, cylinders or spheres of titanium dioxide, zirconium dioxide or mixtures thereof, aluminium oxide, steatite, ceramics, glass, graphite or stainless steel. In the case of the use of catalyst shaped bodies, which is preferred, the inert material should preferably have similar outside dimensions.

Suitable catalyst shaped bodies are shaped bodies of any shape, preferred shapes being lozenges, rings, cylinders, stars, cart wheels or spheres and particularly preferred shapes being rings, cylinders or star-shaped extrudates.

Suitable heterogeneous catalysts are in particular ruthenium compounds or copper compounds on support materials, which can also be doped, with preference being given to optionally doped ruthenium catalysts. Examples of suitable support materials are silicon dioxide, graphite, titanium dioxide of rutile or anatase structure, zirconium dioxide, aluminium oxide or mixtures thereof, preferably titanium dioxide, zirconium dioxide, aluminium oxide or mixtures thereof, particularly preferably γ- or δ-aluminium oxide or mixtures thereof.

The copper or ruthenium supported catalysts can be obtained, for example, by impregnating the support material with aqueous solutions of CuCl₂ or RuCl₃ and optionally of a promoter for doping, preferably in the form of their chlorides. Shaping of the catalyst can take place after or, preferably, before the impregnation of the support material.

Suitable promoters for the doping of the catalysts are alkali metals such as lithium, sodium, potassium, rubidium and caesium, preferably lithium, sodium and potassium, particularly preferably potassium, alkaline earth metals such as magnesium, calcium, strontium and barium, preferably magnesium and calcium, particularly preferably magnesium, rare earth metals such as scandium, yttrium, lanthanum, cerium, praseodymium and neodymium, preferably scandium, yttrium, lanthanum and cerium, particularly preferably lanthanum and cerium, or mixtures thereof.

The shaped bodies can then be dried and optionally calcined at a temperature of from 100 to 400° C., preferably from 100 to 300° C., for example, under a nitrogen, argon or air atmosphere. The shaped bodies are preferably first dried at from 100 to 150° C. and then calcined at from 200 to 400° C.

The hydrogen chloride conversion in a single pass can preferably be limited to from 15 to 90%, preferably from 40 to 85%, particularly preferably from 50 to 70%. After separation, all or some of the unreacted hydrogen chloride can be fed back into the catalytic hydrogen chloride oxidation. The recirculation of hydrogen chloride can be effected from the hydrochloric acid obtained in stage 16, for example by distillation with azeotropic point displacement.

The volume ratio of hydrogen chloride to oxygen at the entrance to the reactor is preferably from 1:1 to 20:1, preferably from 2:1 to 8:1, particularly preferably from 2:1 to 5:1.

The heat of reaction of the catalytic hydrogen chloride oxidation can advantageously be used to produce high-pressure steam. This can be used to operate a phosgenation reactor and/or distillation columns, in particular isocyanate distillation columns.

The separation of unreacted hydrogen chloride and of water vapour that has formed can be carried out by condensing aqueous hydrochloric acid from the product gas stream of the hydrogen chloride oxidation (i.e., “the initial gas mixture”) by cooling. In order that the whole of the unreacted hydrogen chloride can be removed, the addition of water can be necessary. This can be carried out, for example, by adding water to the process gas stream prior to cooling. The addition of water can be carried out, for example, in such a manner that the water is vaporised and, as a result of vaporisation, removes water from the process gas stream, which results in a saving in terms of cooling energy. A further variant is that the unreacted hydrogen chloride is absorbed in dilute hydrochloric acid or water.

A further preferred embodiment of the invention comprises using at least part of the residual chlorine hydrate/water-containing phase for the absorption of hydrogen chloride. Likewise, this aqueous solution can be added prior to cooling of the process gas. A further advantage of such an embodiment is that some of the aqueous solution is always discharged, which can prevent the accumulation of impurities.

A further preferred embodiment is characterised in that the hydrogen chloride used as starting material for the oxidation reaction comprises a product of an isocyanate preparation process, and/or in that the released chlorine gas, preferably freed of oxygen and optionally of minor constituents, can be used in the preparation of isocyanates, more preferably as part of a isocyanate production process from which the hydrogen chloride was obtained.

A particular advantage of such a combined process is that conventional chlorine liquefaction can be dispensed with and the chlorine for recirculation into the isocyanate preparation process can be available at approximately the same pressure level as the inlet stage of the isocyanate preparation process.

A preferred combined process comprises an integrated process for the preparation of isocyanates and the oxidation of hydrogen chloride to recover chlorine for the synthesis of phosgene as starting material for the preparation of isocyanates.

In a first step of such a preferred process, the preparation of phosgene takes place by reaction of chlorine with carbon monoxide. The synthesis of phosgene is sufficiently well known and is described, for example, in Ullmanns Enzyklopädie der industriellen Chemie, 3rd Edition, Volume 13, pages 494-500. Further processes for the preparation of isocyanates are described, for example, in U.S. Pat. No. 4,764,308 and WO 03/72237. On an industrial scale, phosgene is predominantly produced by reaction of carbon monoxide with chlorine, preferably on activated carbon as catalyst. The strongly exothermic gas phase reaction takes place at temperatures of from at least 250° C. to not more than 600° C., generally in tubular reactors. The heat of reaction can be dissipated in various ways, for example by means of a liquid heat-exchange agent, as described, for example, in WO 03/072237, or by vapour cooling via a secondary cooling circuit while simultaneously using the heat of reaction to produce steam, as disclosed, for example, in U.S. Pat. No. 4,764,308.

In a subsequent process step, at least one isocyanate is formed from the phosgene formed according to the first step, by reaction with at least one organic amine or with a mixture of two or more amines. This next process step is also referred to hereinbelow as phosgenation. The reaction takes place with the formation of hydrogen chloride as by-product.

The synthesis of isocyanates is likewise sufficiently well known from the prior art, phosgene generally being used in a stoichiometric excess, based on the amine. The phosgenation is conventionally carried out in the liquid phase, it being possible for the phosgene and the amine to be dissolved in a solvent. Preferred solvents are chlorinated aromatic hydrocarbons, such as, for example, chlorobenzene, o-dichlorobenzene, p-dichlorobenzene, trichlorobenzenes, the corresponding chlorotoluenes or chloroxylenes, chloroethylbenzene, monochlorodiphenyl, α- or β-naphthyl chloride, benzoic acid ethyl ester, phthalic acid dialkyl esters, diisodiethyl phthalate, toluene and xylenes. Further examples of suitable solvents are known from the prior art. As is additionally known from the prior art, for example from WO 96/16028, the resulting isocyanate itself can also serve as the solvent for phosgene. In another, preferred embodiment, the phosgenation, in particular of suitable aromatic and aliphatic diamines, takes place in the gas phase, that is to say above the boiling point of the amine. Gas-phase phosgenation is described, for example, in EP 570799A. Advantages of this process over liquid-phase phosgenation, which is otherwise conventional, are the energy saving which results from the minimisation of a complex solvent and phosgene circuit.

Suitable organic amines are in principle any primary amines having one or more primary amino groups which are able to react with phosgene to form one or more isocyanates having one or more isocyanate groups. The amines have at least one, preferably two, or optionally three or more primary amino groups. Accordingly, suitable organic primary amines are aliphatic, cycloaliphatic, aliphatic-aromatic, aromatic amines, diamines and/or polyamines, such as aniline, halo-substituted phenylamines, for example 4-chlorophenylamine, 1,6-diaminohexane, 1-amino-3,3,5-trimethyl-5-amino-cyclohexane, 2,4-, 2,6-diaminotoluene or mixtures thereof, 4,4-, 2,4′- or 2,2′-diphenylmethanediamine or mixtures thereof as well as higher molecular weight isomeric, oligomeric or polymeric derivatives of the mentioned amines and polyamines. Further possible amines are known from the prior art. Preferred amines for the present invention are the amines of the diphenylmethanediamine group (monomeric, oligomeric and polymeric amines), 2,4-, 2,6-diaminotoluene, isophoronediamine and hexamethylenediamine. In the phosgenation, the corresponding isocyanates diisocyanatodiphenylmethane (MDI, monomeric, oligomeric and polymeric derivatives), toluoylene diisocyanate (TD1, hexamethylene diisocyanate (HDI) and isophorone diisocyanate (IPDI) are obtained.

The amines can be reacted with phosgene in a single-stage or two-stage or, optionally, a multi-stage reaction. A continuous or discontinuous procedure is possible.

If a single-stage phosgenation in the gas phase is chosen, the reaction is carried out above the boiling temperature of the amine, preferably within a mean contact time of from 0.5 to 5 seconds and at temperatures of from 200 to 600° C.

In the case of phosgenation in the liquid phase, temperatures of from 20 to 240° C. and pressures of from 1 to about 50 bar are conventionally used. Phosgenation in the liquid phase can be carried out in a single stage or in a plurality of stages, it being possible to use phosgene in a stoichiometric excess. The amine solution and the phosgene solution are combined via a static mixing element and then guided through one or more reaction columns, for example from bottom to top, where the mixture reacts completely to form the desired isocyanate. In addition to reaction columns provided with suitable mixing elements, reaction vessels having a stirrer device can also be used. As well as static mixing elements, it is also possible to use special dynamic mixing elements. Suitable static and dynamic mixing elements are known from the prior art.

In general, continuous liquid-phase isocyanate production on an industrial scale is carried out in two stages. In the first stage, generally at temperatures of not more than 220° C., preferably not more than 160° C., the carbamoyl chloride is formed from amine and phosgene and amine hydrochloride is formed from amine and cleaved hydrogen chloride. This first stage is highly exothermic. In the second stage, both the carbamoyl chloride is cleaved to isocyanate and hydrogen chloride and the amine hydrochloride is reacted to carbamoyl chloride. The second stage is generally carried out at temperatures of at least 90° C., preferably from 100 to 240° C.

After the phosgenation, the isocyanates formed in the phosgenation are separated off in a third step. This is effected by first separating the reaction mixture of the phosgenation into a liquid and a gaseous product stream in a manner known to the person skilled in the art. The liquid product stream contains substantially the isocyanate or isocyanate mixture, the solvent and a small amount of unreacted phosgene. The gaseous product stream consists substantially of hydrogen chloride gas, phosgene in stoichiometric excess, and small amounts of solvent and inert gases, such as, for example, nitrogen and carbon monoxide. Furthermore, the liquid stream according to the isocyanate separation is then conveyed to a working up step, preferably working up by distillation, wherein phosgene and the solvent are separated off in succession. The isocyanate separation optionally also includes further working up of the resulting isocyanate. This is carried out, for example, by fractionating the resulting isocyanate product in a manner known to the person skilled in the art.

The hydrogen chloride obtained in the reaction of phosgene with an organic amine generally contains organic constituents, which can be disruptive in further processing. These organic constituents include, for example, the solvents used in the isocyanate preparation, such as chlorobenzene, o-dichlorobenzene or p-dichlorobenzene.

The purification of the hydrogen chloride can optionally be carried out in two heat exchangers connected in series according to U.S. Pat. No. 6,719,957, the entire contents of which are incorporated herein by reference. The hydrogen chloride is thereby preferably compressed to a pressure of from 5 to 20 bar, preferably from 10 to 15 bar, and the compressed gaseous hydrogen chloride is fed at a temperature of from 20 to 600° C., preferably from 30 to 50° C., to a first heat exchanger, where the hydrogen chloride is cooled with cold hydrogen chloride having a temperature of from −10 to −30° C. from a second heat exchanger. Organic constituents condense thereby and can be fed to disposal or re-use. The hydrogen chloride passed into the first heat exchanger leaves it at a temperature of from −20 to 0° C. and is cooled in the second heat exchanger to a temperature of from −10 to −30° C. The condensate formed in the second heat exchanger consists of further organic constituents as well as small amounts of hydrogen chloride. In order to avoid losing hydrogen chloride, the condensate leaving the second heat exchanger is fed to a separating and vaporising unit. This can be a distillation column, for example, in which the hydrogen chloride is driven out of the condensate and fed back into the second heat exchanger. It is also possible to feed the hydrogen chloride that has been driven out back into the first heat exchanger. The hydrogen chloride cooled and freed of organic constituents in the second heat exchanger is passed into the first heat exchanger at a temperature of from 10 to −30° C. After heating to from 10 to 30° C., the hydrogen chloride freed of organic constituents leaves the first heat exchanger.

It is, however, likewise conceivable to dispense with the purification of the HCl and instead to purify the aqueous solution circulated in the crystallisation.

The following examples are for reference and do not limit the invention described herein.

### EXAMPLES

### Example 1

### HCl Oxidation Using O₂

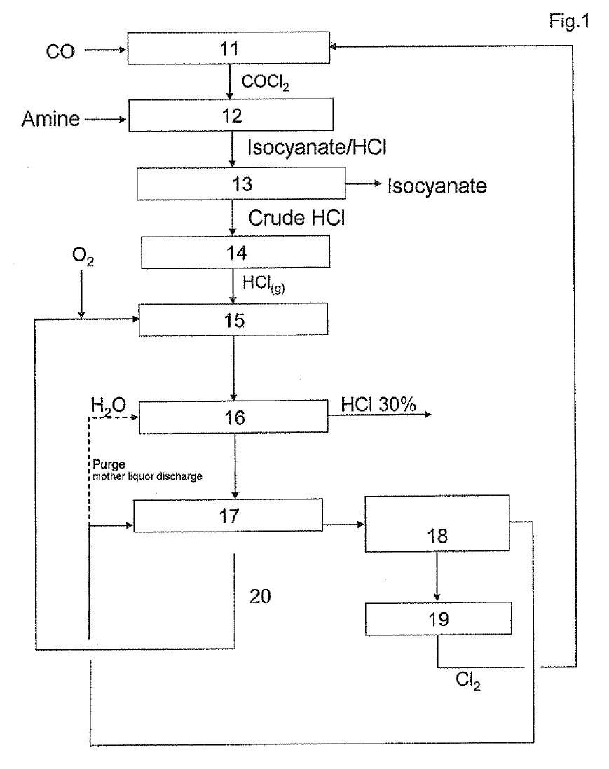

Referring to FIG. 1, an embodiment of a process including isocyanate production according to the invention using oxygen is described. In a first stage 11 of the isocyanate preparation, chlorine is reacted with carbon monoxide to give phosgene. In the following stage 12, phosgene from stage 11 is reacted with an amine (here: toluenediamine) to give an isocyanate (toluene diisocyanate, TDI) and hydrogen chloride, the isocyanate is separated off (stage 13) and utilized, and the HCl gas is subjected to purification 14. The purified HCl gas is reacted in the HCl oxidation process 15 with oxygen (here in a Deacon process by means of catalyst). A process gas stream having the following composition:

| | |
|---|---|
| nitrogen: | 1692.7 kg/h |
| oxygen: | 3068.0 kg/h |
| hydrogen chloride: | 1968.8 kg/h |
| carbon dioxide: | 2807.8 kg/h |
| chlorine: | 15,430.3 kg/h |
| water: | 2507 kg/h |

leaves the reactor. The temperature is 333° C. at a pressure of 2.8 bar.

The process gas stream is fed to stage 16 (as the “initial gas mixture”) and is cooled to 100° C., following which the pressure is 2.6 bar (step 16). This process gas is passed to an HCl absorption step for the removal of hydrogen chloride and water. Hydrogen chloride and water from the process gas are removed in an absorption column. To this end, the gas is introduced above the bottom. Water is applied at the top of the column. In order to increase the amount of substance that passes over and to dissipate the heat of absorption that forms, approximately 33% hydrochloric acid is pumped from the bottom to the top of the column. The circulated hydrochloric acid is cooled by means of a heat exchanger. Hydrogen chloride and water from the process gas are obtained in the form of approximately 33 wt. % hydrochloric acid in the bottom; the residual gas freed of water and hydrogen chloride at the top of the column has the following composition:

| | |
|---|---|
| nitrogen: | 1692.7 kg/h |
| oxygen: | 3068.0 kg/h |
| carbon dioxide: | 2807.7 kg/h |
| chlorine: | 15,408.3 kg/h |
| water: | 118 kg/h |

### The temperature is 26.5° C. at a pressure of 2.3 bar.

The gas mixture so obtained (i.e., the intermediate gas mixture) and further minor constituents such as, for example, carbon monoxide, argon, etc. are fed to a crystallisation stage (step 17), wherein chlorine hydrate precipitates predominantly in the form of hexahydrate solid. The crystallisation (stage 17) can be carried out in a bubble column. From the bubble column, a substance stream having the following composition is applied to a vacuum drum filter:

| | | |
|---|---|---|
| nitrogen: | 1.6 | kg/h |
| oxygen: | 5.9 | kg/h |
| carbon dioxide: | 147.3 | kg/h |
| chlorine: | 350.8 | kg/h |
| water: | 443,884 | kg/h |
| chlorine hydrate: | 23,511.8 | kg/h |
| sodium chloride: | 114,638 | kg/h |

### The temperature is −5° C. at a pressure of 1.35 bar.

The residual gas comprises:

| | |
|---|---|
| nitrogen: | 1692.6 kg/h |
| oxygen: | 3067.7 kg/h |
| carbon dioxide: | 2801.6 kg/h |
| chlorine: | 6166.0 kg/h |
| water: | 13.8 kg/h |

The temperature is −5° C. at a pressure of 1.35 bar. Approximately 10% of the residual gas is fed to disposal. The gas that remains is fed back to the hydrogen chloride oxidation.

A mother liquor having the following composition leaves the filtration:

| | | |
|---|---|---|
| nitrogen: | 1.5 | kg/h |
| oxygen: | 5.7 | kg/h |
| carbon dioxide: | 141.1 | kg/h |
| chlorine: | 336 | kg/h |
| water: | 425,215 | kg/h |
| sodium chloride: | 109,816 | kg/h |

### The temperature is −5° C. at a pressure of 1.35 bar.

After cooling to −10° C. and addition of NaCl-containing water and, optionally, NaCl-containing water from the chlorine hydrate decomposition (stage 19), the mother liquor is fed back to the crystallisation apparatus (e.g., bubble column). Part of the stream is discarded in order to prevent the accumulation of impurities.

The chlorine hydrate that has been filtered off with residues of mother liquor has the following composition and is fed to the chlorine hydrate decomposition (stage 18).

| | | |
|---|---|---|
| nitrogen: | 0.1 | kg/h |
| oxygen: | 0.3 | kg/h |
| carbon dioxide: | 6.1 | kg/h |
| chlorine: | 14.7 | kg/h |
| water: | 18,669 | kg/h |
| sodium chloride: | 4,821.4 | kg/h |
| chlorine hydrate: | 23,511.8 | kg/h |

### The temperature is −5° C. at a pressure of 1.35 bar.

Moist chlorine gas and the minor constituents leave the chlorine hydrate decomposition (stage 18) and are fed to the chlorine drying step (stage 19).

The gas stream from the chlorine hydrate decomposition has the following composition:

| | |
|---|---|
| nitrogen: | 0.1 kg/h |
| oxygen: | 0.3 kg/h |
| carbon dioxide: | 6.1 kg/h |
| chlorine: | 9241.9 kg/h |
| water: | 23.6 kg/h |

The temperature is 11.5° C. at a pressure of 1.2 bar.

The liquid stream leaving the chlorine hydrate decomposition has the following composition:

| | |
|---|---|
| chlorine: | 87 kg/h |
| water: | 32,843 kg/h |
| sodium chloride: | 4821.5 kg/h |

The temperature is 11.5° C. at a pressure of 1.2 bar. This stream can be fed back to the chlorine hydrate formation (stage 17). A partial stream of water from the decomposition 18 is optionally fed to the HCl separation (stage 16).

The chlorine is dried with 96% sulfuric acid (stage 19) and fed back to the phosgene synthesis 11.

### Example 2

### HCl Oxidation Using Air

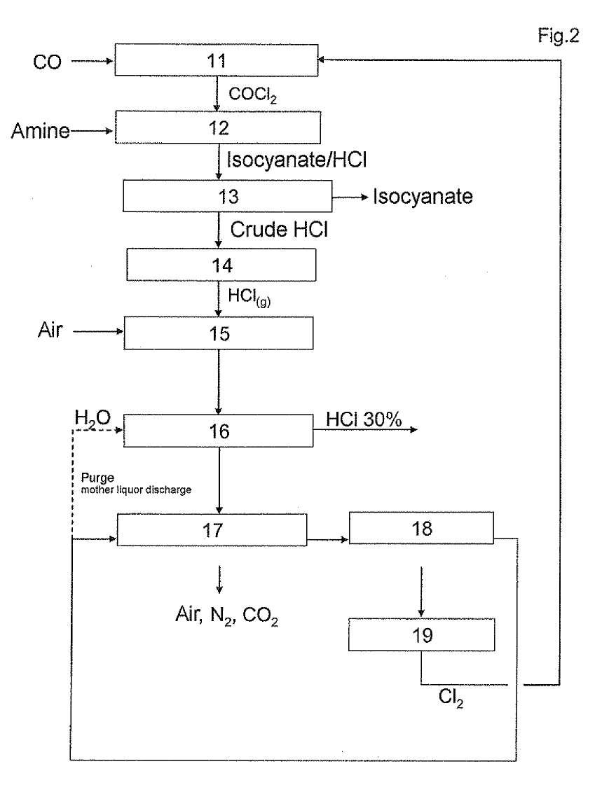

Referring to FIG. 2, another embodiment of a process according to the invention is shown.

In a first stage 11 of the isocyanate preparation, chlorine is reacted with carbon monoxide to give phosgene. In the following stage 12, phosgene from stage 11 is reacted with an amine (e.g., toluenediamine) to give an isocyanate (e.g., toluene diisocyanate, TDI) and hydrogen chloride, the isocyanate is separated off (stage 13) and utilised, and the HCl gas is subjected to purification 14. The purified HCl gas is reacted in the HCl oxidation process 15 with air (in a Deacon process by means of catalyst).

The reaction mixture from 15 is cooled (step 16). Aqueous hydrochloric acid which is formed here, optionally mixed with water or dilute hydrochloric acid, is discharged.

The gas mixture so obtained consisting at least of chlorine, oxygen and optionally minor constituents such as nitrogen, carbon dioxide, etc. and fed to a crystallisation stage (step 17), whereby chlorine hydrate precipitates in the form of a solid. Air, nitrogen and the minor constituents are discharged and optionally disposed of in a controlled manner. The chlorine hydrate obtained in the crystallisation stage 17 is decomposed (stage 18), whereby chlorine and water form. The chlorine is dried with 96% sulfuric acid (stage 19) and fed back to the phosgene synthesis 11. The water from the chlorine hydrate decomposition and excess aqueous phase are fed to the crystallisation stage 17. A partial stream of water from the decomposition 18 is optionally fed back to the HCl separation (stage 16).

### Example 3

### Crystallisation of the Chlorine Hydrate (Introduction in Bubble Form)

In order to demonstrate chlorine purification via crystallised chlorine hydrate, 800 g of once-distilled water are placed in a stirred double-walled glass container having a diameter of 100 mm and adjusted to a temperature of 0° C. at atmospheric pressure. The mixture is stirred at 1000 revolutions per minute using a sloping stirrer (diameter 70 mm). 40 g of chlorine gas are removed from a pressurised bottle and added over a period of 30 minutes at a pressure of 5 mbar. The point of introduction is in the vicinity of the stirrer. When the solubility has been exceeded, solid chlorine hydrate forms in the form of a yellowish precipitate. When the metered addition is complete, the resulting suspension is stirred for a ffurther 40 minutes and then filtered over a suction filter and washed with 500 g of a 10 g/00 g NaCl solution. 32.4 g of moist solid are obtained, from which 5.4 g of chlorine gas are obtained by heating. The solution that remains after melting and outgassing is concentrated by evaporation, and an evaporation residue of 1.7 g is determined. A residual moisture content of the moist solid of 17 g can be determined therefrom with the concentration of the washing solution. The yield of dry chlorine hydrate is thus calculated as 15.4 g and the molar ratio of the bound water of crystallisation to NCl₂/H₂O=7.1.

### Example 4

### Demonstration of Crystallisation with Addition of NaCl

640 g of once-distilled water are placed together with 160 g of NaCl in a stirred double-walled glass container having a diameter of 100 mm and adjusted to a temperature of about −18° C. at atmospheric pressure. The mixture is stirred at 1000 revolutions per minute using a sloping stirrer (diameter 70 mm). 40 g of chlorine gas are removed from a pressurised bottle and added over a period of 30 minutes at a pressure of 5 mbar. The point of introduction is in the vicinity of the stirrer. When the solubility has been exceeded, solid chlorine hydrate forms in the form of a yellowish precipitate. When the metered addition is complete, the resulting suspension is stirred for a further 30 minutes and then filtered over a suction filter. 80.6 g of moist solid are obtained, from which 8.7 g of chlorine gas are obtained by heating. The solution that remains after melting and outgassing is concentrated by evaporation, and an evaporation residue of 11.7 g is determined. A residual moisture content of the moist solid of 58.5 g can be determined therefrom with the concentration of the salt solution. The yield of dry chlorine hydrate is thus calculated as 22.1 g and the molar ratio of the bound water of crystallisation to NCl₂H₂O=6.1.

### Example 5

### Demonstration of Crystallisation with Addition of NaCl, Variation of the Temperature

The procedure of Example 4 is followed, but the temperature is adjusted to a constant −9° C. 45.6 g of moist solid are obtained, from which 5.5 g of chlorine gas are obtained by heating. The solution that remains after melting and outgassing is concentrated by evaporation, and an evaporation residue of 6.3 g is determined. A residual moisture content of the moist solid of 31.5 g can be determined therefrom with the concentration of the salt solution. The yield of dry chlorine hydrate is thus calculated as 14.1 g and the molar ratio of the bound water of crystallisation to NCl₂/H₂O=6.2.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A process comprising:
(a) providing an initial gas mixture comprising chlorine, water, hydrogen chloride and oxygen;
(b) cooling the initial gas mixture to form condensed hydrochloric acid and an intermediate chlorine-containing gas mixture;
(c) contacting the intermediate gas mixture with a water-containing phase under a set of conditions selected from a pressure, a temperature and combinations thereof, to form a chlorine hydrate-containing phase and a remaining gas mixture;
(d) separating the chlorine hydrate-containing phase from the remaining gas mixture;
(e) subjecting the chlorine hydrate-containing phase to a set of conditions selected from heat, pressure relief and combinations thereof to release chlorine and form a residual chlorine hydrate/water-containing phase; and
(f) separating the released chlorine from the residual chlorine hydrate/water-containing phase.

2. The process according to claim 1, wherein the initial gas mixture comprises a reaction product prepared by a reaction of hydrogen chloride and oxygen selected from the group of reactions consisting of thermal oxidations of hydrogen chloride with oxygen in the presence of a catalyst, non-thermally activated oxidations of hydrogen chloride with oxygen, and combinations thereof.

3. The process according to claim 1, further comprising removing residual water from the released chlorine by adsorption, condensation or a combination thereof.

4. The process according to claim 3, wherein removing residual water from the released chlorine comprises adsorption with concentrated sulfuric acid.

5. The process according to claim 1, further comprising feeding at least a portion of the residual chlorine hydrate/water-containing phase to the contacting of the intermediate gas mixture with the water-containing phase.

6. The process according to claim 1, wherein the contacting of the intermediate gas mixture with the water-containing phase is carried out under a set of conditions comprising a pressure of 3 to 30 bar.

7. The process according to claim 1, wherein the contacting of the intermediate gas mixture with the water-containing phase is carried out under a set of conditions comprising a temperature below 30° C.

8. The process according to claim 6, wherein the contacting of the intermediate gas mixture with the water-containing phase is carried out under a set of conditions comprising a temperature below 30° C.

9. The process according to claim 1, wherein the chlorine hydrate-containing phase comprises a compound selected from the group consisting of chlorine hexahydrate, chlorine heptahydrate and mixtures thereof.

10. The process according to claim 1, wherein the water-containing phase further comprises an additive which lowers the solidus of water.

11. The process according to claim 1, wherein the water-containing phase further comprises an additive selected from the group consisting of chloride and hypochlorite salts of alkali and alkaline earth metals, and mixtures thereof.

12. The process according to claim 1, wherein contacting the intermediate gas mixture with the water-containing phase comprises adding an excess of the water-containing phase to form a suspension of chlorine hydrate in the water-containing phase.

13. The process according to claim 12, further comprising separating solid chlorine hydrate from the suspension.

14. The process according to claim 1, wherein the water-containing phase is combined with the intermediate gas mixture in metered amounts such that chlorine hydrate forms as a dry solid in the remaining gas mixture.

15. The process according to claim 1, wherein the chlorine hydrate-containing phase comprises crystalline chlorine hydrate.

16. The process according to claim 1, wherein the set of conditions during the contacting of the intermediate gas mixture with the water-containing phase comprises lowering the temperature and maintaining or increasing the pressure.

17. The process according to claim 1, wherein the set of conditions during the contacting of the intermediate gas mixture with the water-containing phase comprises increasing the pressure and maintaining the temperature.

18. The process according to claim 1, wherein the set of conditions the chlorine hydrate-containing phase is subjected to release chlorine comprises raising the temperature and maintaining or lowering the pressure.

19. The process according to claim 1, wherein the set of conditions the chlorine hydrate-containing phase is subjected to release chlorine comprises lowering the pressure and maintaining the temperature.

20. The process according to claim 1, wherein the water-containing phase is saturated with chlorine gas prior to contact with the intermediate gas mixture.

21. The process according to claim 1, wherein the water-containing phase comprises chlorine hydrate prior to contact with the intermediate gas mixture.

22. The process according to claim 1, wherein contacting the intermediate gas mixture with a water-containing phase comprises introducing the intermediate gas into the water-containing phase in bubble form.

23. The process according to claim 22, wherein introducing the intermediate gas into the water-containing phase in bubble form is carried out in an apparatus selected from the group consisting of bubble columns, crystallizers and combinations thereof.

24. The process according to claim 23, wherein the apparatus comprises a bubble column and the intermediate gas is passed countercurrently through the water-containing phase.

25. The process according to claim 23, wherein the ratio of the intermediate gas to the water-containing phase, the temperature and the pressure are adjusted such that solids content in the apparatus is 1 to 50 parts by volume, based on the apparatus volume.

26. The process according to claim 1, wherein contacting the intermediate gas mixture with a water-containing phase comprises feeding the intermediate gas to a space above the water-containing phase such that the contacting occurs at an intermediate gas mixture/water-containing phase surface boundary.

27. The process according to claim 2, wherein the hydrogen chloride is a product of an isocyanate production process.

28. The process according to claim 27, further comprising feeding at least a portion of the released chlorine back to the isocyanate production process.

29. The process according to claim 28, further comprising feeding at least a portion of the residual chlorine hydrate/water-containing phase to the contacting of the intermediate gas mixture with the water-containing phase.
